(19) United States
(12) Patent Application Publication
(10) Pub. No.: US 2026/0031576 A1
(43) Pub. Date: Jan. 29, 2026

(54) CONNECTOR AND CONNECTOR ASSEMBLY

(71) Applicant: Tyco Electronics (Shanghai) Co., Ltd., Shanghai (CN)

(72) Inventors: Daokuan (Jeremy) Zhang, Shanghai (CN); Yong (Chris) Wang, Shanghai (CN); Hart (Hua) He, Shanghai (CN); Xinzheng (Tony) Fan, Shanghai (CN); Jianfei (Fencer) Yu, Shanghai (CN); Weidong (Randy) Huang, Shanghai (CN); Fren Chen, Shanghai (CN)

(73) Assignee: Tyco Electronics (Shanghai) Co., Ltd., Shanghai (CN)

(21) Appl. No.: 19/278,024

(22) Filed: Jul. 23, 2025

(30) Foreign Application Priority Data
Jul. 23, 2024 (CN) 202421754889.8

(51) Int. Cl. H01R 13/6582; H01R 13/627; H01R 13/6592

(52) U.S. Cl. CPC H01R 13/6582; H01R 13/6272; H01R 13/6592

(57) ABSTRACT

A connector includes an insulator. The connector further includes a terminal retained in the insulator. The connector further includes a shield case sleeved on the insulator. The connector further includes an outer housing arranged on the shield case, the shield case is provided with an elastic snap lock, the elastic snap lock extending from the outer housing and being configured to be locked to a mating connector to ensure that the connector and the mating connector are securely locked in a mating state.

### CROSS-REFERENCE TO RELATED APPLICATIONS

This application claims the benefit of Chinese Patent Application No. CN 202421754889.8 filed on Jul. 23, 2024 in the State Intellectual Property Office of China, the whole disclosure of which is incorporated herein by reference.

### FIELD OF THE INVENTION

The present invention pertains to a connector, and a connector assembly comprising the connector.

### BACKGROUND

USB-C connectors generally include a male connector and a female connector mating with the male connector. Generally, there is no locking structure on the male connector and the female connector that can lock the two in a mating state. Therefore, when subjected to vibration, there is a risk of momentary disconnection between terminals of the male connector and the female connector, which will cause signal interruption and signal discontinuity.

### SUMMARY

A connector includes an insulator, a terminal retained in the insulator, a shield case sleeved on the insulator, and an outer housing arranged on the shield case. The shield case is provided with an elastic snap lock, extending from the outer housing and being configured to be locked to a mating connector to ensure that the connector and the mating connector are securely locked in a mating state.

### BRIEF DESCRIPTION OF DRAWINGS

The invention is described in more detail with references to the drawings in which:

FIG. 1 is an perspective view of a connector assembly according to an exemplary embodiment of the invention;

FIG. 2 is an exploded view of the connector assembly;

FIG. 3 is a perspective view of a mating connector according to the exemplary embodiment of the invention;

FIG. 4 is a perspective view of a connector; and

FIG. 5 is a perspective view of a rear shield case and a wiring board of a connector according to the exemplary embodiment of the invention.

### DETAILED DESCRIPTION OF THE EMBODIMENTS

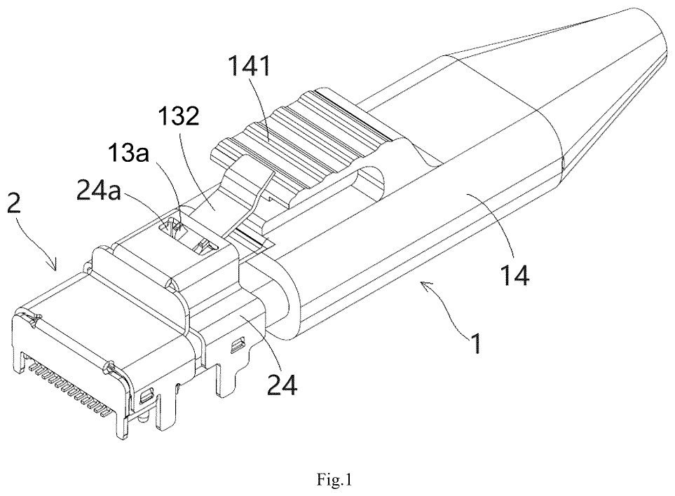

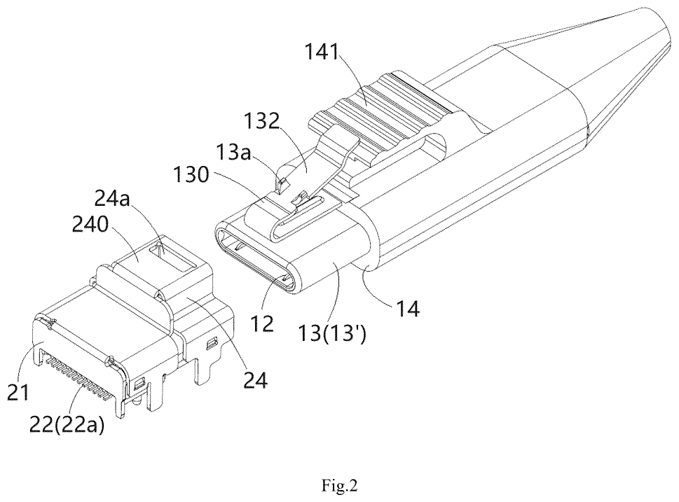

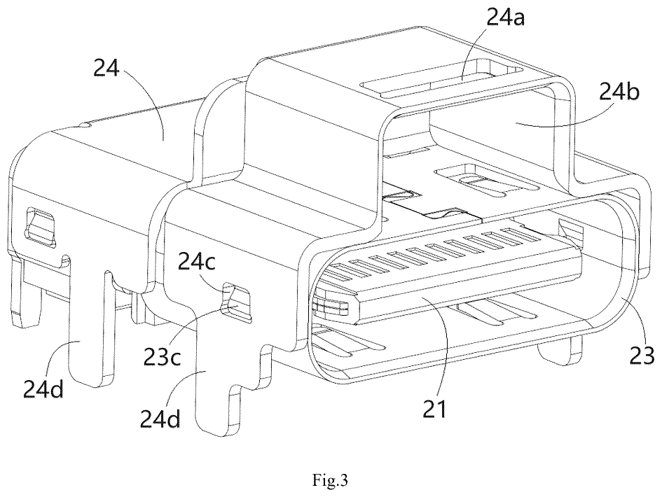

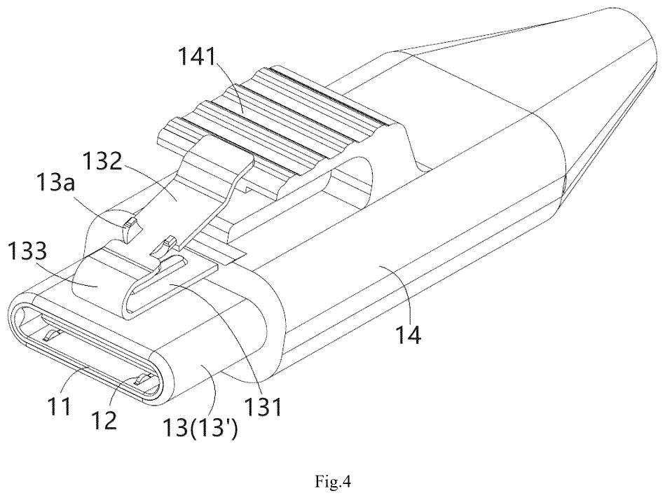

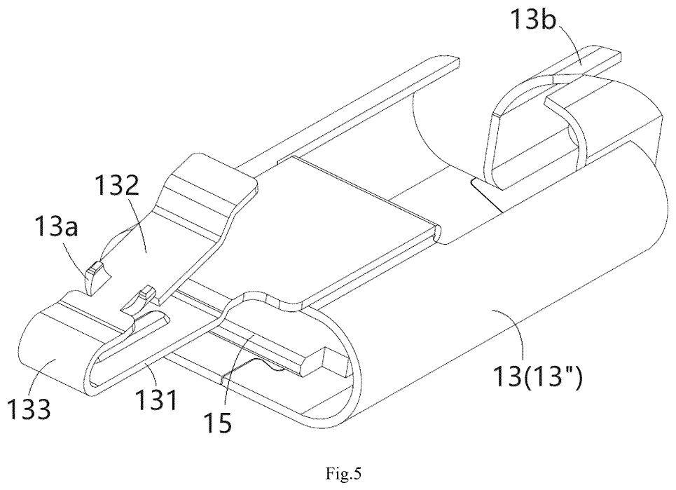

As shown in FIGS. 1 to 5, in an exemplary embodiment of the invention, a connector 1 is disclosed. The connector 1 includes: an insulator 11; a terminal 12; a shield case 13; and an outer housing 14. The terminal 12 is retained in the insulator 11, the shield case 13 is sleeved on the insulator 11, and the outer housing 14 is arranged on the shield case 13. The shield case 13 is provided with an elastic snap lock 130. The elastic snap lock 130 extends from the outer housing 14 and is configured to be locked to a mating connector 2 to ensure that the connector 1 and the mating connector 2 are securely locked in a mating state.

As shown in FIGS. 1 to 5, in the illustrated embodiment, the elastic snap lock 130 includes: a first elastic arm 131; a second elastic arm 132; and an arc-shaped connecting arm 133. The first elastic arm 131 has a rear end connected to a top wall of the shield case 13, and the first elastic arm 131 extends forwardly from the rear end thereof in a horizontal direction. The second clastic arm 132 is located above the first elastic arm 131 and extends rearwardly from a front end thereof in an upwardly inclined direction. The arc-shaped connecting arm 133 is connected between a front end of the first elastic arm 131 and the front end of the second elastic arm 132. A locking protrusion 13a is formed on the second elastic arm 132. The locking protrusion 13a is close to the front end of the second elastic arm 132 and is configured to be locked into a snap slot 24a of the mating connector 2.

As shown in FIGS. 1 to 5, in the illustrated embodiment, the second elastic arm 132 is adapted to move between a locked position engaged with the snap slot 24a of the mating connector 2 and an unlocked position disengaged from the snap slot 24a of the mating connector 2.

As shown in FIGS. 1 to 5, in the illustrated embodiment, an elastic cantilever 141 is formed on the outer housing 14, and a rear end of the second elastic arm 132 is engaged together with an end portion of the elastic cantilever 141, such that the second elastic arm 132 can be moved from the locked position to the unlocked position by pressing the elastic cantilever.

As shown in FIGS. 1 to 5, in the illustrated embodiment, the outer housing 14 is an injection molded part directly formed on the shield case 13 by means of an insert injection molding process, such that the shield case 13 and the outer housing 14 form an integral part.

As shown in FIGS. 1 to 5, in the illustrated embodiment, the shield case 13 includes: a front shield case 13′; and a rear shield case 13″ soldered to a rear end of the front shield case 13′. The insulator 11 is arranged in the front shield case 13′, and the elastic snap lock 130 is formed on the rear shield case 13″.

As shown in FIGS. 1 to 5, in the illustrated embodiment, the connector further includes: a wiring board 15 arranged in the rear shield case 13″; and a cable. A core wire of the cable is soldered to the wiring board 15. The terminal 12 is soldered to the wiring board 15, the wiring board 15 is configured to electrically connect the terminal 12 to the cable, and the cable is led out from a rear end of the outer housing 14.

As shown in FIGS. 1 to 5, in the illustrated embodiment, a crimping portion 13b is formed at a rear end of the rear shield case 13″, and the crimping portion 13b is configured to be crimped onto a shield layer of the cable to establish an electrical connection with the shield layer of the cable.

As shown in FIGS. 1 to 5, in the illustrated embodiment, a front portion of the front shield case 13′ extends from the outer housing 14 and is configured to be inserted into a mating shield case 23 of the mating connector 2 for mating with the mating shield case 23.

As shown in FIGS. 1 to 5, in the illustrated embodiment, the connector 1 is a USB-C connector.

As shown in FIGS. 1 to 5, in another exemplary embodiment of the present utility model, a connector assembly is disclosed. The connector assembly includes: a connector 1 and a mating connector 2. The mating connector 2 mates with the connector 1. The mating connector 2 includes: a retainer 21; a mating terminal 22; a mating shield case 23; and an outer cover 24. The mating terminal 22 is arranged in the retainer 21. The mating shield case 23 is sleeved on the retainer 21. The outer cover 24 is mounted to the exterior of the mating shield case 23. The mating terminal 22 mates with the terminal 12 of the connector 1, the mating shield case 23 mates with the shield case 13 of the connector 1, and the outer cover 24 is configured to fix the mating connector 2 to a circuit board. The outer cover 24 is provided with a snap lock structure 240 located above the top of the mating shield case 23. The snap lock structure 240 is engaged with the elastic snap lock 130 of the connector 1 to lock the connector 1 and the mating connector 2 in a mating state.

As shown in FIGS. 1 to 5, in the illustrated embodiment, the snap lock structure 240 of the outer cover 24 includes a receiving recess 24b formed at the top of the outer cover 24 and a snap slot 24a formed in a top wall of the receiving recess 24b. A front portion of the elastic snap lock 130 of the connector 1 is inserted into the receiving recess 24b of the outer cover 24, and the locking protrusion 13a of the elastic snap lock 130 is engaged into the snap slot 24a.

As shown in FIGS. 1 to 5, in the illustrated embodiment, the outer cover 24 has a top wall and a pair of side walls, and the snap lock structure 240 is formed on the top wall of the outer cover 24. Slotted holes 24c are formed in the side walls of the outer cover 24, protrusions 23c are formed on outer sides of side walls of the mating shield case 23, and the protrusions 23c are locked into the slotted holes 24c, to fix the outer cover 24 to the mating shield case 23.

As shown in FIGS. 1 to 5, in the illustrated embodiment, the top wall of the outer cover 24 is soldered to an outer side of the top wall of the mating shield case 23, and the pair of side walls of the outer cover 24 are soldered to the outer sides of a pair of side walls of the mating shield case 23, respectively.

As shown in FIGS. 1 to 5, in the illustrated embodiment, a plurality of plug pins 24d are formed on lower side edges of the pair of side walls of the outer cover 24, respectively. The plurality of plug pins 24d are configured to be respectively inserted into a plurality of sockets on the circuit board to fix the mating connector 2 to the circuit board.

As shown in FIGS. 1 to 5, in the illustrated embodiment, the mating terminal 22 has a soldering pin 22a exposed from the bottom of the retainer 21, the soldering pin 22a of the mating terminal 22 is configured to be soldered to the circuit board.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present utility model are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
an insulator;
a terminal retained in the insulator;
a shield case sleeved on the insulator; and
an outer housing arranged on the shield case, the shield case having an elastic snap lock, the elastic snap lock extending from the outer housing and being configured to be locked to a mating connector.

2. The connector of claim 1, wherein the elastic snap lock includes a first elastic arm having a rear end connected to a top wall of the shield case, the first elastic arm extending forwardly from the rear end thereof in a horizontal direction.

3. The connector of claim 2, wherein the elastic snap lock includes a second elastic arm located above the first elastic arm and extending rearwardly from a front end thereof in an upwardly inclined direction.

4. The connector of claim 3, wherein the elastic snap lock further includes an arc-shaped connecting arm connected between the front end of the first elastic arm and the front end of the second elastic arm.

5. The connector of claim 4, wherein a locking protrusion is formed on the second elastic arm, the locking protrusion being close to the front end of the second elastic arm and configured to be locked into a snap slot of the mating connector.

6. The connector of claim 5, wherein the second elastic arm is adapted to move between a locked position engaged with the snap slot of the mating connector and an unlocked position disengaged from the snap slot of the mating connector.

7. The connector of claim 6, wherein an elastic cantilever is formed on the outer housing, and the rear end of the second elastic arm is engaged together with an end portion of the elastic cantilever, such that the second elastic arm can be moved from the locked position to the unlocked position by pressing the elastic cantilever.

8. The connector of claim 1, wherein the outer housing is an injection molded part directly formed on the shield case by means of an insert injection molding process, such that the shield case and an outer housing form an integral part.

9. The connector of claim 1, wherein the shield case includes a front shield case and a rear shield case soldered to a rear end of the front shield case.

10. The connector of claim 9, wherein the insulator is arranged in the front shield case, and the elastic snap lock is formed on the rear shield case.

11. The connector of claim 10, wherein the connector further includes a wiring board arranged in the rear shield case and a cable, a core wire of the cable being soldered to the wiring board, the terminal is soldered to the wiring board, the wiring board is configured to electrically connect the terminal to the cable, and the cable is led out from the rear end of the outer housing.

12. The connector of claim 11, wherein a crimping portion is formed at the rear end of the rear shield case, the crimping portion being configured to be crimped onto a shield layer of the cable to establish an electrical connection with the shield layer of the cable.

13. The connector of claim 11, wherein a front portion of the front shield case extends from the outer housing and is configured to be inserted into a mating shield case of the mating connector for mating with the mating shield case.

14. The connector of claim 1, wherein the connector is a USB-C connector.

15. A connector assembly, comprising:
a connector;
a mating connector mating with the connector, the mating connector includes
a retainer;
a mating terminal arranged in the retainer;
a mating shield case sleeved on the retainer;
an outer cover mounted to the exterior of the mating shield case, the mating terminal mates with a terminal of the connector, the mating shield case mates with a shield case of the connector, and the outer cover is configured to fix the mating connector to a circuit board; and
the outer cover has a snap lock structure located above the top of the mating shield case, the snap lock structure being engaged with an elastic snap lock of the connector to lock the connector and the mating connector in a mating state.

16. The connector assembly of claim 15, wherein the snap lock structure of the outer cover comprises a receiving recess formed at the top of the outer cover and a snap slot formed in a top wall of the receiving recess and a front portion of the elastic snap lock of the connector is inserted into the receiving recess of the outer cover, and a locking protrusion of the elastic snap lock is engaged into the snap slot.

17. The connector assembly of claim 15, wherein the outer cover has a top wall and a pair of side walls, and the snap lock structure is formed on the top wall of the outer cover and slotted holes are formed in side walls of the outer cover, protrusions are formed on outer sides of side walls of the mating shield case, and the protrusions are locked into the slotted holes, to fix the outer cover to the mating shield case.

18. The connector assembly of claim 17, wherein the top wall of the outer cover is soldered to an outer side of the top wall of the mating shield case, and the pair of side walls of the outer cover are soldered to the outer sides of the pair of side walls of the mating shield case, respectively.

19. The connector assembly of claim 17, wherein a plurality of plug pins are formed on lower side edges of the pair of side walls of the outer cover, respectively, the plurality of plug pins being configured to be respectively inserted into a plurality of sockets on the circuit board to fix the mating connector to the circuit board.

20. The connector assembly of claim 17, wherein the mating terminal has a soldering pin exposed from the bottom of the retainer, the soldering pin of the mating terminal being configured to be soldered to the circuit board.
